(19) United States
(12) Patent Application Publication
(10) Pub. No.: US 2011/0301255 A1
(43) Pub. Date: Dec. 8, 2011

(54) EPOXIDE-BASED STRUCTURAL FOAM COMPRISING THERMOPLASTIC POLYURETHANES

(75) Inventors: Emilie BARRIAU, Duesseldorf (DE); Olaf LAMMERSCHOP, Danville, CA (US); Thomas ENGELS, Duesseldorf (DE); Sven WUCHERPFENNIG, Dormagen (DE); Petra PADURSCHEL, Monheim (DE); Mario MARCOLINI, Hirschberg (DE); Martin RENKEL, Duesseldorf (DE)

(73) Assignee: Henkel AG & Co. KGaA, Duesseldorf (DE)

(21) Appl. No.: 13/095,206

(22) Filed: Apr. 27, 2011

Related U.S. Application Data
(63) Continuation of application No. PCT/EP2009/062311, filed on Sep. 23, 2009.

(30) Foreign Application Priority Data
Oct. 28, 2008 (DE) 10 2008 053 520.6

(51) Int. Cl. C08L 75/04

(52) U.S. Cl. 521/137

(57) ABSTRACT

Disclosed is a thermally expandable and curable material containing: a) at least one epoxide prepolymer; b) at least one heat-activated curing agent for the prepolymer; c) at least one foaming agent; and d) at least one thermoplastic, non-reactive polyurethane selected from among polyurethanes containing a polyester chain. Also disclosed are the use of such a material for stiffening or reinforcing components as well as an extruded or injection-molded article made of such a material.

### CROSS-REFERENCE TO RELATED APPLICATIONS

This application is a continuation under 35 U.S.C. Section 365(c) and 120 of International Application No. PCT/EP2009/062311, filed Sep. 23, 2009 and published on May 6, 2010 as WO 2010/049221, which claims priority from German Patent Application No. 10 2008 053 520.6 filed Oct. 28, 2008, which are incorporated herein by reference in their entirety.

### FIELD OF THE INVENTION

The present invention relates to foamable and hardenable epoxy resin mixtures that, in the foamed and cured state, can be used as structural foams to stiffen, in particular, metallic hollow structures. The compounds have low tackiness, so that they on the one hand they can be inexpensively shaped in injection molding machines, and on the other hand they require no particular packaging method because of their reduced tackiness. In order to reduce tackiness, the epoxy resin mixtures have added to them thermoplastic polyurethanes which are selected so that on the one hand the uncured compound has the desired low tackiness, and on the other hand the cured compound has the required mechanical properties.

### BACKGROUND OF THE INVENTION

Lightweight components for dimensionally consistent series production with high stiffness and structural strength are necessary for many areas of application. In vehicle engineering in particular, because of the weight saving desirable in that context, there is a great demand for lightweight components made of thin-walled structures that nevertheless possess sufficient stiffness and structural strength. One approach to achieving high stiffness and structural strength with the lowest possible component weight utilizes hollow parts that are produced from relatively thin sheet metal or plastic panels. Thin-walled metal sheets tend to deform easily, however. It has therefore been known for some time to foam out this cavity in hollow-body structures with a structural foam, which on the one hand prevents or minimizes deformation, and on the other hand enhances the strength and stiffness of these parts.

Foamed reinforcing and stiffening agents of this kind usually either are metal foams, or contain a thermally hardenable resin or binders such as, for example, epoxy resins. These compositions as a rule contain a blowing agent, fillers, and reinforcing fillers such as, for example, hollow microspheres made of glass. Such foams preferably have, in the foamed and cured state, a density from 0.3 to 0.7 g/cm³. After curing, these foams are said to withstand temperatures of more than 130° C., preferably more than 150° C., at least for a short time, without damage. Foamable, thermally hardenable compositions of this kind generally contain further constituents such as curing agents, process adjuvants, stabilizers, dyes or pigments, if applicable UV absorbers and adhesion-intensifying constituents.

WO 96/37400 describes a W-shaped reinforcing structure that contains a thermally expandable resin-like material and is introduced, before curing, into the hollow element to be reinforced. The reinforcing polymer matrix is by preference made up of a one-component, dough-like system containing an epoxy resin, an acrylonitrile-butadiene rubber, fillers, high-strength glass spheres, a hardener and an accelerator, and a blowing agent based on an azo compound or a hydrazide compound.

WO 00/27920 discloses expandable sealing and damping compositions that are mixtures of a thermoplastic resin or multiple thermoplastic resins, and an epoxy resin. These are said to be injection-moldable and to possess light weight and high compressive strength. The following are recited as examples of thermoplastic resins: solid rubbers such as styrene-butadiene rubbers and nitrile-butadiene rubbers, or polystyrene polymers such as, for example, SBS block copolymers. The epoxy resin is preferably liquid.

German patent application DE 102006048739 describes binders for the manufacture of expandable, thermally curable shaped elements, which contain

at least one epoxy resin,
at least one polyester that is solid at room temperature,
at least one blowing agent,
at least one hardener, and
at least one filler.

“Flexibilizing agents” can additionally be contained. Solid rubbers, for example, are recited as flexibilizing agents. Examples of suitable solid rubbers are polybutadiene, styrene-butadiene rubber, butadiene-acrylonitrile rubber, EPDM, synthetic or natural isoprene rubber, butyl rubber, or polyurethane rubber. Partly crosslinked solid rubbers based on isoprene-acrylonitrile copolymers or butadiene-acrylonitrile polymers are particularly suitable.

WO 2007/004184 describes a thermally foamable material that contains the following components:

a) a solid epoxy resin that is substantially free of liquid or semi-solid epoxy resin,

b) an impact improver,

c) a hardener, and

d) a heat-activatable blowing agent.

The impact improver can represent a thermoplastic material. The following are recited, for example: epoxy-polyurethane hybrids and isocyanate prepolymers (for example, isocyanate-terminated polyether polyols) that have a molecular weight in the range between 1000 and 10,000 g/mol. A number of block copolymers are also recited as impact improvers. These can have a core-shell structure.

WO 2007/025007 discloses a composition having the following components:

a) at least one epoxy resin,

b) rubber particles having a core-shell structure,

c) a further impact modifier or toughness improver, and

d) a heat-activatable latent hardener.

In addition, the composition can contain blowing agents so that it can be used as a structural foam. Recited as components c) are, for example, polyurethanes that derive from hydroxyl-terminated polyoxyalkylenes, for example polypropylene glycol or polytetrahydrofuran diol. These should exhibit thermoplastic behavior. Instead of or in addition to these, block copolymers can also be present, for example those in which at least one polymer block has a glass temperature below 20° C. (by preference below 0° C. or below −30° C. or below −50° C.), for example a polybutadiene block or a polyisoprene block. At least one further block of the block copolymer has a glass temperature above 20° C. (by preference above 50° C. or above 70° C.), for example a polystyrene block or a polymethyl methacrylate block. Styrene-butadiene-methyl methacrylate block copolymers, methyl methacrylate-butadiene-methyl methacrylate block copolymers, and butadiene-methyl methacrylate block copolymers are recited as concrete examples.

Three-dimensional parts made of structural foams are usually manufactured today using the injection molding method. Because of the tackiness of the materials at temperatures above 30° C., the starting material for manufacturing parts using the injection mold method cannot be used as a granulate. To allow parts nevertheless to be manufactured with this method, the system for delivering material to the injection molding machine must be expensively modified. A special delivery system is necessary, and it is thus not possible to carry out parts manufacture on any commercially usual injection molding machines.

If formulations having a higher melting point are used in order to increase the softening point to approx. 40° C., the structural foam part must be processed in the injection molding machine at higher temperatures in order to fill the molds. Temperatures above 100° C. are not permissible, since otherwise the curing reaction of the composition is initiated and this can result in blockage of the machine.

As a result of the high viscosity at temperatures just above the melting point of the epoxy resins, and in particular because of the tackiness of the liquefied epoxy resins, injection-molded parts can be manufactured only very poorly and with considerable technical complexity. This usually requires the processing machinery to be specially equipped, thereby raising capital costs.

As a result of the internal tackiness of the melt casting compound, the flow behavior in the injection molding machine and the injection molds is greatly degraded. The tackiness of the hot melt casting compound based on epoxy resins can result in contamination of equipment, thereby greatly increasing maintenance and cleaning costs. Release agents can be used as a remedy. This can result, however, in corrosion on tools and machinery, which in turn increases the maintenance requirement.

### SUMMARY OF THE INVENTION

The object addressed by the present invention is that of making available injection molding compounds, based on epoxy resins, in which the problems recited above occur not at all or to a greatly diminished extent.

The present invention relates to a thermally expandable and hardenable compound containing

a) at least one epoxy prepolymer,

b) at least one heat-activatable hardener for the prepolymer,

c) at least one blowing agent,

d) at least one thermoplastic non-reactive polyurethane that is selected from polyurethanes that contain a polyester chain.

The thermoplastic polyurethane d) is preferably solid at room temperature (22° C.) and has a glass temperature below −20° C., by preference below −30° C. The thermoplastic polyurethane d) that is by preference solid at room temperature furthermore has a melting range or softening range (Kofler method) that begins above 100° C., by preference above 115° C.

Suitable polyurethanes d) that are by preference solid at room temperature are further notable for the fact that they have, as a pure substance, an elongation at fracture of at least 300%, by preference at least 400%.

The number-average molecular weight of suitable polyurethanes d), as determinable by gel permeation chromatography, is by preference in the range from 50,000 g/mol to 120,000 g/mol, in particular in the range from 55,000 g/mol to 90,000 g/mol.

### DETAILED DESCRIPTION OF THE INVENTION

Polyester-based thermoplastic polyurethanes having the properties recited above are particularly suitable on the one hand for bringing about the desired low tackiness in the compounds according to the present invention and thus simpler processing of them by injection molding, and on the other hand for imparting the necessary mechanical stability to the cured compound. Thermoplastic polyurethanes selected differently either do not result in the desired low tackiness of the uncured compound, or reduce the mechanical properties of the cured compound to values that do not meet requirements. Compounds that in the cured state have a modulus of elasticity of at least 1000 MPa and a compressive strength of at least 15 MPa are regarded as suitable in this context, while compounds having values below these are regarded as less suitable for the intended application.

Suitable thermoplastic polyurethanes that meet the above criteria are obtainable commercially, and can be procured on the basis of these specifications from, for example, the Merquinsa company in Spain or Danquinsa GmbH in Germany.

Those thermoplastic polyurethanes that contain a polycaprolactone polyester chain are particularly suitable as thermoplastic polyurethanes d) having the properties recited above.

The epoxy prepolymers, hereinafter also referred to as “epoxy resins,” can in principle be saturated, unsaturated, cyclic or acyclic, aliphatic, alicyclic, aromatic, or heterocyclic polyepoxide compounds.

Suitable epoxy resin systems in the context of the present invention are, for example, preferably selected from epoxy resins of the bisphenol A type, epoxy resins of the bisphenol S type, epoxy resins of the bisphenol F type, epoxy resins of the phenol novolac type, epoxy resins of the cresol novolac type, epoxidized products of numerous dicyclopentadiene-modified phenol resins obtainable by the reaction of dicyclopentadiene with numerous phenols, epoxidized products of 2,2′,6,6′-tetramethylbiphenol, aromatic epoxy resins such as epoxy resins having a naphthalene basic framework and epoxy resins having a fluorene basic framework, aliphatic epoxy resins such as neopentyl glycol diglycidyl ethers and 1,6-hexanediol diglycidyl ethers, alicyclic epoxy resins such as 3,4-epoxycyclohexylmethyl-3,4-epoxycyclohexane carboxylate and bis(3,4-epoxycyclohexyl) adipate, and epoxy resins having a hetero ring, such as triglycidyl isocyanurate. The epoxy resins encompass in particular, for example, the reaction product of bisphenol A and epichlorohydrin, the reaction product of phenol and formaldehyde (novolac resins) and epichlorohydrin, glycidyl esters, and the reaction product of epichlorohydrin and p-aminophenol.

Further polyphenols that yield suitable epoxy resin prepolymers by reaction with epichlorohydrin (or epibromohydrin) are: resorcinol, 1,2-dihydroxybenzene, hydroquinone, bis(4-hydroxyphenyl)-1,1-isobutane, 4,4-dihydroxybenzophenone, bis(4-hydroxyphenyl)-1,1-ethane, and 1,5-hydroxynaphthalene.

Further suitable polyepoxides are polyglycidyl ethers of polyalcohols or diamines. Polyglycidyl ethers of this kind are derived from polyalcohols such as, for example, ethylene glycol, diethylene glycol, triethylene glycol, 1,2-propylene glycol, 1,4-butylene glycol, triethylene glycol, 1,5-pentanediol, 1,6-hexanediol, or trimethylolpropane.

Further preferred epoxy resins that are commercially obtainable encompass, in particular, octadecylene oxide, epichlorohydrin, styrene oxide, vinylcyclohexene oxide, glycidol, glycidyl methacrylate, diglycidyl ethers of bisphenol A (e.g. those obtainable under the commercial designations “Epon 828”, “Epon 825”, “Epon 1004” and “Epon 1010” of Hexion Specialty Chemicals Inc., “DER-331”, “DER-332”, “DER-334”, “DER-732” and “DER-736” of Dow Chemical Co.), vinylcyclohexene dioxide, 3,4-epoxycyclohexylmethyl-3,4-epoxycyclohexene carboxylate, 3,4-epoxy-6-methylcyclohexylmethyl-3,4-epoxy-6-methylcyclohexene carboxylate, bis(3,4-epoxy-6-methylcyclohexylmethyl) adipate, bis(2,3-epoxycyclopentyl) ether, aliphatic epoxide modified with polypropylene glycol, dipentene dioxide, epoxidized polybutadiene (e.g. Krasol products of Sartomer), silicone resins containing epoxide functionality, flame-retardant epoxy resins (e.g. “DER-580”, a brominated epoxy resin of the bisphenol type obtainable from Dow Chemical Co.), 1,4-butanediol diglycidyl ethers of a phenol/formaldehyde novolac (e.g. “DEN-431” and “DEN-438” of the Dow Chemical Co.), as well as resorcinol diglycidyl ethers (e.g. “Kopoxite” of the Koppers Company Inc.), bis(3,4-epoxycyclohexyl) adipate, 2-(3,4-epoxycyclohexyl-5,5-spiro-3,4-epoxy)cyclohexanemetadioxane, vinylcyclohexene monoxide, 1,2-epoxyhexadecane, alkyl glycidyl ethers such as, for example, C8-C10-alkyl glycidyl ethers (e.g. “HELOXY Modifier 7” of Flexion Specialty Chemicals Inc.), C12-C14-alkyl glycidyl ethers (e.g. “HELOXY Modifier 8” of Hexion Specialty Chemicals Inc.), butyl glycidyl ethers (e.g. “HELOXY Modifier 61” of Hexion Specialty Chemicals Inc.), cresyl glycidyl ethers (e.g. “HELOXY Modifier 62” of Hexion Specialty Chemicals Inc.), p-tert-butylphenyl glycidyl ethers (e.g. “HELOXY Modifier 65” of Hexion Specialty Chemicals Inc.), polyfunctional glycidyl ethers such as, for example, diglycidyl ethers of 1,4-butanediol (e.g. “HELOXY Modifier 67” of Hexion Specialty Chemicals Inc.), diglycidyl ethers of neopentyl glycol (e.g. “HELOXY Modifier 68” of Flexion Specialty Chemicals Inc.), diglycidyl ethers of cyclohexanedimethanol (e.g. “HELOXY Modifier 107” of Flexion Specialty Chemicals Inc.), trimethylolethane triglycidyl ethers (e.g. “HELOXY Modifier 44” of Hexion Specialty Chemicals Inc.), trimethylolpropane triglycidyl ethers (e.g. “HELOXY Modifier 48” of Hexion Specialty Chemicals Inc.), polyglycidyl ethers of an aliphatic polyol (e.g. “HELOXY Modifier 84” of Hexion Specialty Chemicals Inc.), polyglycol diepoxide (e.g. “HELOXY Modifier 32” of Hexion Specialty Chemicals Inc.), bisphenol F epoxies (e.g. “EPN-1138” or “GY-281” of Huntsman Int. LLC), 9,9-bis-4-(2,3-epoxypropoxy)phenylfluorenone (e.g. “Epon 1079” of Hexion Specialty Chemicals Inc.).

Further preferred commercially obtainable compounds are selected, for example, from Araldit™ 6010, Araldit™ GY281™, Araldit™ ECN-1273, Araldit™ ECN-1280, Araldit™ MY-720, RD-2 of Huntsman Int. LLC; DEN™ 432, DEN™ 438, DEN™ 485 of Dow Chemical Co., Epon™ 812, 826, 830, 834, 836, 871, 872, 1001, 1031 etc. of Hexion Specialty Chemicals Inc. and HPT™ 1071, HPT™ 1079 likewise of Hexion Specialty Chemicals Inc., as novolac resins furthermore, for example, Epi-Rez™ 5132 of Hexion Specialty Chemicals Inc., ESCN-001 of Sumitomo Chemical, Quatrex 5010 of Dow Chemical Co., RE 305S of Nippon Kayaku, Epiclon™ N673 of DaiNipon Ink Chemistry, or Epicote™ 152 of Hexion Specialty Chemicals Inc.

In addition, the following polyepoxides can also be used at least in portions: polyglycidyl esters of polycarboxylic acids, for example reaction products of glycidol or epichlorohydrin with aliphatic or aromatic polycarboxylic acids such as oxalic acid, succinic acid, glutaric acid, terephthalic acid, or dimer fatty acid.

The epoxy equivalent of suitable polyepoxides can vary between 150 and 50,000, by preference between 170 and 5000. For example, an epoxy resin based on epichlorohydrin/bisphenol A that has an epoxy equivalent weight from 475 to 550 gfeq, or an epoxy group content in the range from 1820 to 2110 mmol/g, is suitable. The softening point, determined according to RPM 108-C, is in the range from 75 to 85° C.

The thermally expandable and hardenable compound can contain at least one epoxy prepolymer a) that is liquid at room temperature (22° C.). This simplifies processing of the compound during injection molding. The presence of an epoxy prepolymer of this kind that is liquid at room temperature usually results in undesired tackiness. This is, however, reduced again by the thermoplastic polyurethane d) present according to the present invention, to a sufficient extent that the compound is readily processable using the injection molding method.

Reaction products of epichlorohydrin with bisphenol A or bisphenol F are preferably used as epoxy prepolymers that are liquid at room temperature. These typically have epoxy equivalent weights in the range from approximately 150 to approximately 480.

Thermally activatable or latent hardeners for the epoxy resin binder system are used as hardeners. These can be selected from the following compounds: guanidines, substituted guanidines, substituted ureas, melamine resins, guanamine derivatives, cyclic tertiary amines, aromatic amines, and/or mixtures thereof. The hardeners can be involved stoichiometrically in the hardening reaction, but they can also be catalytically active. Examples of substituted guanidines are methylguanidine, dimethylguanidine, trimethylguanidine, tetramethylguanidine, methylisobiguanidine, dimethylisobiguanidine, tetramethylisobiguanidine, hexamethylisobiguanidine, heptamethylisobiguanidine, and very particularly cyanoguanidine (dicyandiamide). Representatives of suitable guanamine derivatives that may be cited are alkylated benzoguanamine resins, benzoguanamine resins, or methoxymethylethoxymethylbenzoguanamine. Dicyandiamide is preferably suitable.

In addition to or instead of the aforesaid hardeners, catalytically active substituted ureas can be used. These are, in particular, p-chlorophenyl-N,N-dimethylurea (monuron), 3-phenyl-1,1-dimethylurea (fenuron), or 3,4-dichlorophenyl-N,N-dimethylurea (diuron). In principle, catalytically active tertiary acrylamines or alkylamines such as, for example, benzyldimethylamine, tris(dimethylamino)phenol, piperidine, or piperidine derivatives can also be used. In addition, a variety of (by preference, solid) imidazole derivatives can be used as catalytically active accelerators. Representatives that may be named are 2-ethyl-2-methylimidazole, N-butylimidazole, benzimidazole, and N-C₁ to -C₁₂ alkylimidazoles or N-arylimidazoles. Adducts of amino compounds with epoxy resins are also suitable as accelerating additives to the aforesaid hardeners. Suitable amino compounds are tertiary aliphatic, aromatic, or cyclic amines. Suitable epoxy compounds are, for example, polyepoxides based on glycidyl ethers of bisphenol A or F, or of resorcinol. Concrete examples of such adducts are adducts of tertiary amines such as 2-dimethylaminoethanol, N-substituted piperazines, N-substituted homopiperazines, N-substituted aminophenols with di- or polyglycidyl ethers of bisphenol A or F or of resorcinol.

Suitable blowing agents are, in principle, all known blowing agents such as, for example, the “chemical blowing agents” that release gases by decomposition, or “physical blowing agents,” i.e. expanding hollow spheres. Examples of the former blowing agents are azobisisobutyronitrile, azodicarbonamide, di-nitrosopentamethylenetetramine, 4,4′-oxybis(benzenesulfonic acid hydrazide), diphenylsulfone-3,3′-disulfohydrazide, benzene-1,3-disulfohydrazide, p-toluenesulfonylsemicarbamide. The expandable hollow plastic microspheres based on polyvinylidene chloride copolymers or acrylonitrile/(meth)acrylate copolymers are particularly preferred. These are commercially obtainable, for example, under the names “Dualite®” and “Expancel®” from the Pierce & Stevens and Casco Nobel companies, respectively.

The quantity of blowing agent is preferably selected so that upon heating to activation temperature (or expansion temperature), the volume of the compound irreversibly increases by at least 10%, by preference at least 20%, and in particular at least 50%. This is to be understood to mean that upon heating to activation temperature the compound, in addition to the normal and reversible thermal expansion in accordance with its coefficient of thermal expansion, irreversibly increases its volume, as compared with the initial volume at room temperature (22° C.), in such a way that after being cooled back to room temperature it is at least 10%, by preference at least 20%, and in particular at least 50% larger than before. The degree of expansion indicated thus refers to the volume of the compound at room temperature before and after temporary heating to activation temperature. The upper limit of the expansion factor, i.e. the irreversible volume increase, can be set by selecting the quantity of blowing agent, in such a way that it is less than 300%, in particular less than 200%.

The activation temperature is by preference in the range from 120 to 220° C. This temperature is preferably to be maintained for a time period in the range from 10 to 150 minutes.

The compound by preference contains, as an additional component e), at least one block copolymer. This is by preference selected from those that contain a first polymer block having a glass transition temperature below 15° C., in particular below 0° C., and a second polymer block having a glass transition temperature above 25° C., in particular above 50° C. Those block copolymers that are selected from ones in which a first polymer block is selected from a polybutadiene block or polyisoprene block, and a second polymer block is selected from a polystyrene block or a polymethyl methacrylate block, are further suitable.

For example, the block copolymer e) is selected from copolymers having the following block structure: styrene-butadiene-(meth)acrylate, styrene-butadiene-(meth)acrylic acid ester, ethylene-(meth)acrylic acid ester-glycidyl (meth)acrylic acid ester, ethylene-(meth)acrylic acid ester-maleic acid anhydride, (meth)acrylic acid ester-butyl acrylate-(meth)acrylic acid ester, by preference methyl methacrylate-butyl acrylate-methyl methacrylate.

The block copolymers recited above correspond to those that can also be used in the context of WO 2007/025007 cited above. More detailed information thereon, and further block copolymers also suitable in the context of the present invention, may be gathered from page 25, line 21 to page 26, line 9 of said document. Also contained therein are cross-references to documents in which the manufacture of such block copolymers is described.

The composition of these block copolymers is defined above by indicating the monomer unit for each block. This is to be understood to mean that each block copolymer contains polymer blocks made of the recited monomers. In the individual polymer blocks, up to 20 mol % of the recited monomers can be replaced by other comonomers. This applies in particular to blocks made of polymethyl methacrylate.

The aforesaid block copolymers improve the impact strength of the cured compounds according to the present invention, in particular at temperatures below 0° C.

In addition to or instead of the block copolymers recited above, the compound according to the present invention can contain, as a further component f), rubber particles. These likewise contribute to an improvement in the impact strength of the cured compound, in particular at temperatures below 0° C. These rubber particles preferably have a core-shell structure.

It is preferred in this context that the rubber particles having a core-shell structure comprise a core made of polymer material having a glass transition temperature below 0° C., and an envelope made of a polymer material having a glass transition temperature above 25° C. Particularly suitable rubber particles having a core-shell structure can comprise a core made of a diene homopolymer, a diene copolymer, or a polysiloxane elastomer, and/or a shell made of an alkyl (meth)acrylate homopolymer or copolymer.

The core of these core-shell particles can, for example, contain a diene homopolymer or copolymer, which can be selected from a homopolymer of butadiene or isoprene, a copolymer of butadiene or isoprene with one or more ethylenically unsaturated monomers, for example vinyl aromatic monomers, (meth)acrylonitrile, (meth)acrylates, or similar monomers. The polymer or copolymer of the shell can contain as monomers, for example: (meth)acrylates such as in particular methyl methacrylate, vinyl aromatic monomers (e.g. styrene), vinyl cyanides (e.g. acrylonitrile), unsaturated acids or anhydrides (e.g. acrylic acid), (meth)acrylamides, and similar monomers that result in polymers having a suitably high glass temperature.

The polymer or copolymer of the shell can comprise acid groups that can crosslink by metal carboxylate formation, for example by forming a salt with divalent metal cations. The polymer or copolymer of the shell can furthermore be covalently crosslinked by utilizing monomers that comprise two or more double bonds per molecule.

Other rubber-like polymers, for example poly(butyl acrylate), or polysiloxane elastomers, for example polydimethylsiloxane, in particular crosslinked polydimethylsiloxane, can be used as a core.

These core-shell particles are typically constructed so that the core accounts for 50 to 95 wt % of the core-shell particle, and the shell for 5 to 50 wt % of said particle.

By preference, these rubber particles are relatively small. For example, the average particle size (as determinable, for example, using light scattering methods) can be in the range from approximately 0.03 to approximately 2 μm, in particular in the range from approximately 0.05 to approximately 1 μm. Smaller core-shell particles can, however, also be used, for example those whose average diameter is less than approximately 500 nm, in particular less than approximately 200 nm. For example, the average particle size can be in the range from approximately 25 to approximately 200 nm.

The manufacture of such core-shell particles is known in the existing art, as indicated for example on page 6, lines 16 to 21 of WO 2007/025007.

Commercial procurement sources for core-shell particles of this kind are listed in this document in the last paragraph of page 6 to the first paragraph of page 7. Reference to said procurement sources is hereby made. Reference is further made to manufacturing methods for such particles that are described in the aforesaid document from page 7, second paragraph to page 8, first paragraph. For more detailed information about suitable core-shell particles, reference is likewise made to the aforesaid document WO 2007/025007, which contains extensive information thereon from page 8, line 15 to page 13, line 15.

Inorganic particles that comprise an envelope made of organic polymers can take on the same function as the rubber particles recited above having a core-shell structure. A further preferred embodiment of the present invention is therefore characterized in that the compound according to the present invention contains, as an additional component g), inorganic particles that comprise an envelope made of organic polymers.

In this embodiment the compound according to the present invention preferably contains inorganic particles that comprise an envelope made of organic polymers, the organic polymers being selected from homo- or copolymers of acrylic acid esters and/or methacrylic acid esters, and being made up of at least 30 wt % polymerized-in acrylic acid esters and/or methacrylic acid esters.

The esters of acrylic acid and/or of methacrylic acid preferably represent methyl esters and/or ethyl esters; particularly preferably, at least a portion of the esters are present as methyl esters. In addition, the polymers can also contain unesterified acrylic acid and/or methacrylic acid, which can improve the attachment of the organic polymers to the surface of the inorganic particles. It is therefore particularly preferred in this case if the monomer units made up of unesterified acrylic acid and/or methacrylic acid are located at or close to that end of the polymer chain which binds to the surface of the inorganic particles.

It is preferred in this context that the organic polymers be made up of at least 80 wt % esters of acrylic acid and/or of methacrylic acid. In particular, they can contain 90 wt %, 95 wt %, or be made up entirely, thereof. If the organic polymers contain monomers other than these esters of acrylic acid and/or of methacrylic acid or unesterified acrylic acid and/or methacrylic acid, they are selected by preference from comonomers that comprise epoxy, hydroxy, and/or carboxyl groups.

The organic polymers of the envelope are by preference uncrosslinked, or so weakly crosslinked that no more than 5% of the monomer units of one chain are crosslinked with monomer units of another chain. It may be advantageous in this context for the polymers to be more greatly crosslinked in the vicinity of the surface of the inorganic particles than farther out in the envelope. In particular, the envelope is by preference constructed so that at least 80%, in particular at least 90%, and particularly preferably 95% of the polymer chains are attached at one end to the surface of the inorganic particles.

The inorganic particles by preference have, before application of the envelope made of organic polymers, an average particle size in the range from 1 to 1000, in particular in the range from 5 to 30 nm. It is known that the particle size can be determined by light scattering methods and by electron microscopy.

The envelope made of organic polymers has a lower density than the inorganic particles themselves. The envelope made of organic polymers preferably has a thickness such that the weight ratio of the inorganic core to the envelope made of organic polymers is in the range from 2:1 to 1:5, by preference in the range from 3:2 to 1:3. This can be controlled by selecting the reaction conditions during growth of the envelope made of organic polymers onto the inorganic particles.

In general, the inorganic particles can be selected from metals, oxides, hydroxides, carbonates, sulfates, and phosphates. Mixed forms made up of oxides, hydroxides, and carbonates, for example basic carbonates or basic oxides, can also be present. If inorganic particles made of metals are selected, then iron, cobalt, nickel, or alloys that are made up of at least 50 wt % of one of said metals, are preferably suitable. Oxides, hydroxides, or mixed forms thereof are preferably selected from those of silicon, cerium, cobalt, chromium, nickel, zinc, titanium, iron, yttrium, zirconium, and/or aluminum. Mixed forms of these are also possible, for example particles made of aluminosilicates or silicate glasses. Zinc oxide, aluminum oxides or hydroxides, and SiO₂ or the oxide forms of silicon referred to as “silicic acid” or “silica” are particularly preferred. The inorganic particles can furthermore be made up of carbonates, for example calcium carbonate, or of sulfates, for example barium sulfate.

It is of course also possible for particles having inorganic cores of different compositions to be present alongside one another.

In order to manufacture the inorganic particles that comprise an envelope made of organic polymers, it is possible to proceed, for example, as described in WO 2004/111136 A1 using the example of coating zinc oxide with alkylene ethercarboxylic acids. According to this procedure, the untreated inorganic particles are suspended in a nonpolar or weakly polar solvent, monomeric or prepolymeric constituents of the envelope are then added, the solvent is removed, and polymerization is started, for example radically or photochemically. It is further possible to proceed by analogy with the manufacturing method described in EP 1 469 020 A1, in which monomers or prepolymers of the envelope material are used as organic coating components for the particles. Also possible is manufacture of the encased particles by “atom transfer radical polymerization,” as has been described, using the example of the polymerization of n-butyl acrylate on silicic acid nanoparticles, in G. Carrot, S. Diamanti, M, Manuszak, B. Charleux, J.-P. Vairon, “Atom transfer radical polymerization of n-butyl acrylate from silica nanoparticles,” J. Polym. Sci., Part A: Polymer Chemistry, Vol. 39, 4294-4301 (2001).

Manufacturing methods as described in WO 2006/053640 can also be resorted to. For the present invention, the inorganic cores to be selected in this context are those described, with their manufacturing methods, on page 5, line 24 to page 7, line 15 of WO 2006/053640. The coating of these cores is accomplished in a manner analogous to that described on page 10, line 22 to page 15, line 7 of this document. The recommendation of this document (page 15, lines 9 to 24) to subject the inorganic cores to a pretreatment before the jacket is polymerized on, can also be followed. What is stated on this subject at the location cited is:

In particular when inorganic cores are used, it may also be preferred for the core to be subjected, before the jacket is polymerized on, to a pretreatment that enables attachment of the jacket. This can usually consist in a chemical functionalization of the particle surface, as is known from the literature from a very wide variety of inorganic materials. It may be particularly preferred in this context to apply onto the surface chemical functions that, as a reactive chain end, enable grafting of the jacket polymers. Terminal double bonds, epoxy functions, and polycondensable groups may be mentioned here, in particular, as examples. The functionalization of hydroxy-group-carrying surfaces with polymers is known, for example, from EP-A-337 144.”

As a rule the substance mixtures usable according to the present invention furthermore contain fillers known per se, for example the various ground or precipitated chalks, carbon black, calcium-magnesium carbonates, talc, barite, and in particular silicate fillers of the aluminum-magnesium-calcium silicate type, for example wollastonite, chlorite. Mica-containing fillers can preferably also be used; very particularly preferred here is a so-called two-component filler made of muscovite mica and quartz with a low heavy-metal content.

For weight reduction, the preparation can also contain, in addition to the aforesaid “normal” fillers, so-called lightweight fillers. These can be selected from the group of the hollow metal spheres such as, for example, hollow steel spheres, hollow glass spheres, fly ash (fillite), hollow plastic spheres based on phenol resins, epoxy resins, or polyesters, expanded hollow microspheres having a wall material made of (meth)acrylic acid ester copolymers, polystyrene, styrene/(meth)acrylate copolymers, and in particular of polyvinylidene chloride as well as copolymers of vinylidene chloride with acrylonitrile and/or (meth)acrylic acid esters, ceramic hollow spheres, or organic lightweight fillers of natural origin such as ground nut shells, for example the shells of cashew nuts, coconuts, or peanuts, as well as cork flour or coke powder. Particularly preferred in this context are those lightweight fillers, based on hollow microspheres, that ensure high compressive strength in the cured preparation.

In a particularly preferred embodiment, the thermally hardenable compounds additionally contain fibers, for example based on aramid fibers, carbon fibers, metal fibers (made, for example, of aluminum), glass fibers, polyamide fibers, polyethylene fibers, or polyester fibers, these fibers by preference being pulp fibers or staple fibers that have a fiber length between 0.5 and 6 mm and a diameter from 5 to 20 μm. Polyamide fibers of the aramid fiber type, or also polyester fibers, are particularly preferred in this context.

The hardenable compounds according to the present invention can further contain common additional adjuvants and additives such as, for example, plasticizers, rheology adjuvants, wetting agents, adhesion promoters, aging protection agents, stabilizers, and/or color pigments. The quantitative ratios of the individual components can vary within relatively wide limits depending on the requirements profile in terms of processing properties, flexibility, required stiffening effect, and adhesive bond to the substrates.

If applicable, the compositions according to the present invention can contain reactive diluents in order to adjust the flow behavior. Reactive diluents for purposes of this invention are low-viscosity substances (glycidyl ethers or glycidyl esters) containing epoxy groups and having an aliphatic or aromatic structure. Typical examples of reactive diluents are mono-, di- or triglycidyl ethers of C₆ to C₁₄ monoalcohols or alkylphenols, as well as the monoglycidyl ethers of cashew-shell oil; diglycidyl ethers of ethylene glycol, diethylene glycol, triethylene glycol, tetraethylene glycol, propylene glycol, dipropylene glycol, tripropylene glycol, tetrapropylene glycol, 1,4-butylene glycol, 1,5-pentanediol, 1,6-hexanediol, and cyclohexanedimethanol; triglycidyl ethers of trimethylolpropane, and the glycidyl esters of C₆ to C₂₄ carboxylic acids, or mixtures thereof.

Typical ranges for the essential components, indicated in wt % based on the entire compound, are:

a) epoxy prepolymer: 10 to 65%, by preference 20 to 60%,
b) heat-activatable hardener for the prepolymer: 1 to 10%, by preference 2 to 8%,
c) blowing agent: 0.5 to 10%, by preference 1 to 5%,
d) thermoplastic non-reactive polyurethane: 1 to 50%, by preference 5 to 35%, in particular 10 to 20%,
e) block copolymer: 0 to 50, by preference 5 to 30%,
f) rubber particles: 0 to 40%, by preference at least 5 and at most 25%,
g) inorganic particles that comprise an envelope made of organic polymers: 0 to 40%, by preference at least 5 and at most 25%,
h) fillers: 0 to 50%, by preference at least 5 and at most 30%, the sum of the total constituents equaling 100 wt %.

The compositions according to the present invention can easily be manufactured in granulate form and can thus easily be temporarily stored and transported in conventional containers, big bags, barrels, or sacks. They can be further processed in conventional injection molding systems without special storage, dispensing, and conveying devices. The structural foams producible from these compositions have properties under compressive or bending stress that are comparable in quality to those of previously known compositions based on epoxies. Surprisingly, despite having good flow behavior in the injection molding machine, the compositions according to the present invention exhibit, in the basic body fabrication sequence in the context of vehicle manufacture, no runoff or washout in the cleaning and pretreatment baths at 65° C. and with simultaneous flow stress. In addition, no tackiness of the shaped elements or granulates is observed at temperatures below 45° C.

By preference, thermally expandable shaped elements that can be used to stiffen and/or reinforce metal components are manufactured, using the injection molding method at low pressures and low temperatures, from the expandable, thermally hardenable compositions.

To accomplish this, for example, the substance mixture can be extruded through a die with the aid of an extruder at a temperature in the range from 50 to 100° C., and after cooling to a temperature below 50° C. can be cut into pieces. In a context of extrusion through a correspondingly shaped die and cutting to the desired length, it is thus possible to manufacture shaped elements whose shape is adapted to the cavity that is to be stiffened. What is thereby obtained, for example, is a shaped element made of a reactive, crosslinking compound that is expandable by at least 20% at a temperature in the range from 120 to 220° C.

An alternative to this is to select a method for manufacturing shaped elements from a substance mixture as described above, the substance mixture being introduced with the aid of an extruder into an injection mold at a temperature in the range from 50 to 100° C., and being unmolded after cooling to a temperature below 50° C.

For extrusion, it is possible to proceed from a substance mixture that is fed into the extruder as a premixed but unshaped compound, or that is mixed together from the individual raw materials only in the extruder itself. It is also possible, however, to utilize the substance mixture in the form of the granulate described above. This is then melted, prior to introduction into the extruder or preferably in the extruder itself, and in that state pressed into the injection mold.

This method variant is characterized by the following essential method steps:

a) mixing the above-described composition constituents at temperatures below 100° C., by preference between 80 and 95° C.,
b) extruding the composition at temperatures below 100° C., preferably 80° C. to 95° C., forming a granulate, optionally onto a cooled metal belt,
c) cooling the granulate thereby formed,
d) if applicable, temporarily storing the granulate, by preference in containers, big bags, barrels, or sacks,
e) conveying the granulate into an injection molding machine,
f) melting the granulate at temperatures below 100° C., and injecting the melt into the predetermined mold of the injection molding machine,
g) cooling the shaped element that has been formed, and removing the shaped element from the mold.

The content of thermoplastic polyurethane(s) d) causes the tackiness of the epoxy-resin-containing compound to be reduced sufficiently that a release agent does not need to be used for the extrusion or injection-molding process.

In addition, the present invention encompasses an extruded or injection-molded shaped element made of a thermally expandable and hardenable compound according to the description above.

The principal application of the shaped elements according to the present invention is the stiffening and reinforcement of components, in particular components for white goods, or of body components such as chassis frames, doors, trunk lids, engine compartment hoods, and/or roof parts, in automotive engineering. The present invention therefore also encompasses a vehicle or a metallic component that is stiffened or reinforced with at least one of the above-described shaped elements obtained by extrusion or by injection molding.

The present invention encompasses in particular a method for reinforcing, insulating, damping, and/or sealing hollow components, in which a shaped element obtained according to the present invention is fastened, before completion of the hollow component, to an inner wall of the hollow component, and the hollow component is closed off and heated to a temperature in the range from 120 to 220° C., by preference for a time period in the range from 10 to 150 minutes.

This method makes use of the usual production process for elongated hollow structures in vehicle engineering, for example for the frames that surround the passenger compartment. These hollow structures are usually produced by manufacturing two correspondingly shaped half-shells from metal, and joining these half-shells together to yield the hollow frame structure or a portion thereof. Hollow structures or hollow supports of this kind are, for example, the A-, B-, or C-pillar of an automobile body that support the roof structure, or also roof frames, sills, and parts of the wheel housings or engine supports. As is usual in the existing art with the use of so-called “pillar fillers” or “baffles” in hollow structures of this kind, the shaped element obtained according to the present invention can be fastened, with the aid of a fastening element or a tacky surface portion, onto that surface of the one half-shell which will later become the inner wall of the cavity, before said half-shell is joined to the other half-shell to constitute the hollow structure.

The shaped element obtained according to the present invention is preferably shaped in such a way that its cross section (viewed perpendicular to the longitudinal axis) corresponds to the cross-sectional shape of the cavity. The shaped element is, however, dimensioned so that prior to foaming, it is in contact with the inner wall of the hollow part at only one or a few points. Aside from these points, a flow gap having a width of approximately 1 to approximately 10 mm, by preference approximately 2 to approximately 4 mm, remains between the delimiting surfaces located parallel to the longitudinal axis of the shaped element and the inner walls of the hollow part. This flow gap ensures that the various process fluids with which the basic auto body is treated can wet every part of the inner sides of the cavity walls. The flow gap closes up only upon thermal expansion of the shaped element, with the result that the latter fulfils its purpose of reinforcing, insulating, damping, and/or sealing the hollow components. Spacers on the shaped elements can guarantee that this flow gap is reliably produced before foaming of the shaped element, and is maintained until foaming.

### EXEMPLIFYING EMBODIMENTS

The effectiveness according to the present invention of component d) (the thermoplastic non-reactive polyurethane selected from polyurethanes that contain a polyester chain) was examined using the following basic formula. A variety of thermoplastic non-reactive polyurethanes were used in this context, abbreviated in the summary below simply as “TPU”.

Basic formula:

1. Epoxy resin: 40 wt %

### 2. TPU: 15 wt %

3. Calcium carbonate: 11 wt %
4. Glass spheres: 24.6 wt %
5. Dicyandiamide+accelerator (Ajicure AH 300, a fenuron derivative): 6 wt %
6. Physical blowing agent (Expancel 091 DU 140, Akzo Nobel): 2 wt %
7. Pyrolytic silicic acid: 1 wt %
8. Carbon black: 0.4 wt %

These components were mixed with one another as follows: component 2 was incorporated into previously provided component 1 in a planetary mixer at 120° C. The mixture was then cooled to 80° C., and components 3 and 4 were added thereto and mixed for 30 minutes. Lastly, components 5, 6, 7, and 8 were added and mixed in for 10 minutes. A vacuum was then applied to the mixture for 5 minutes.

From mixtures according to the present invention having little or no tackiness, it was possible to manufacture injection-molded parts using the following process parameters: temperature 20 to 80° C., dispensing rate 15 m/min, back pressure 5 bar, dispensing volume 8 cm³, injection pressure 350 bar.

After foaming and curing at 150° C., the compounds exhibited an expansion factor in a broad range between 48 and 85%, as a rule in a narrower range between 60 and 80%.

The injection molding suitability of the compounds was assessed on the basis of tackiness. The modulus of elasticity and compressive strength of the cured and foamed compound (measured respectively in MPa), constituting essential mechanical parameters, were determined. Compounds that exhibit, in the cured state, a modulus of elasticity of at least 1000 MPa and a compressive strength of at least 15 MPa are regarded as suitable, while compounds having values below these are regarded as less suitable for the intended application. Suitable mixtures meet both the requirements for low tackiness in the uncured state and requirements in terms of the aforesaid mechanical properties in the cured and foamed state.

A compound that contained no TPU was produced as a negative control. The other constituents in accordance with the listing above were correspondingly recalculated to 100 wt %. Although this negative control had a modulus of elasticity of 1237 MPa and a compressive strength of 26.5 MPa after foaming and curing (expansion factor: 69%), i.e. it met the mechanical requirements, it nevertheless proved not to be injection-moldable because of its high tackiness.

The following examples according to the present invention met all requirements:

### Example 1

TPU=polyester-based polyurethane, number-average molecular weight: 62,150+/−100, melting range (Kofler method): 155 to 165° C., tensile strength per DIN 53504: 35 MPa, elongation at fracture per DIN 53504: 420%, glass transition temperature (DSC, 10° C. per minute): −22° C.

The compound had little tackiness and was injection-moldable without deposits. Values after foaming and curing: expansion factor: 74%, modulus of elasticity: 1109 MPa, compressive strength: 22 MPa.

When 10% of this TPU was used in the above mixture, and the proportions of the other components were correspondingly recalculated to 100%, the following values were obtained: injection-moldable compound with no deposits, expansion factor after curing: 74%, modulus of elasticity: 1163 MPa, compressive strength: 25 MPa.

### Example 2

TPU polyester-based polyurethane, number-average molecular weight: 110,000+1/−2000, softening range (Kofler method): 120 to 130° C., tensile strength: 25 MPa, elongation at fracture: 700%, glass transition temperature (DSC, 10° C. per minute): −32° C.

The uncured compound exhibited no tackiness. After foaming and curing, an expansion factor of 84% was obtained. Modulus of elasticity: 1199 MPa, compressive strength: 15 MPa.

### Example 3

TPU=thermoplastic polyurethane based on polycaprolactone polyester. Melting range (Kofler method): 127 to 137° C., tensile strength: 30 MPa, elongation at fracture: 700%, glass transition temperature (DSC, 10° C. per minute): −32° C., number-average molecular weight: 88,500+/−500.

The uncured compound was not tacky and was extrudable with no problems. After foaming and curing: expansion factor: 72%, modulus of elasticity: 1442 MPa, compressive strength: 25 MPa.

### COMPARATIVE EXAMPLES

For comparison, a variety of polyether-based TPUs were investigated as the TPU in the above basic formula. The compounds thereby obtained did in some cases exhibit the desired low tackiness, but the requisite mechanical properties after foaming and curing were not achieved in any instance. Three different examples yielded the following values:

### Comparison 1

Modulus of elasticity: 855 MPa, compressive strength: 13 MPa.

### Comparison 2

Modulus of elasticity: 801 MPa, compressive strength: 10 MPa.

### Comparison 3

Modulus of elasticity: 396 MPa, compressive strength: 16 MPa.

What we claim is:

1. A thermally expandable and hardenable compound comprising components:
a) at least one epoxy prepolymer,
b) at least one heat-activatable hardener for the prepolymer,
c) at least one blowing agent, and
d) at least one thermoplastic non-reactive polyurethane that is selected from polyurethanes that contain a polyester chain.

2. The thermally expandable and hardenable compound according to claim 1, wherein d) is solid at 22° C. and has a glass temperature below −20°.

3. The thermally expandable and hardenable compound according to claim 1, wherein d) is solid at 22° C. and has a melting range or softening range that begins above 100° C.

4. The thermally expandable and hardenable compound according to claim 1, wherein d) is solid at 22° C. and has, as a pure substance, an elongation at fracture of at least 300%.

5. The thermally expandable and hardenable compound according to claim 1, wherein d) has a number-average molecular weight in a range from 50,000 g/mol to 120,000 g/mol.

6. The thermally expandable and hardenable compound according to claim 1, wherein d) contains a polycaprolactone polyester chain.

7. The thermally expandable and hardenable compound according to claim 1, wherein the at least one epoxy prepolymer a) is liquid at 22° C.

8. The thermally expandable and hardenable compound according to claim 1, further comprising component e) at least one block copolymer.

9. The thermally expandable and hardenable compound according to claim 8, wherein the block copolymer e) is selected from block copolymers that contain a first polymer block having a glass transition temperature below 15° C. and a second polymer block having a glass transition temperature above 25° C.

10. The thermally expandable and hardenable compound according to claim 1, further comprising component f) rubber particles.

11. The thermally expandable and hardenable compound according to claim 10, wherein the rubber particles have a core-shell structure.

12. The thermally expandable and hardenable compound according to claim 1, further comprising component g) inorganic particles that comprise an envelope made of organic polymers.

13. The thermally expandable and hardenable compound according to claim 1, wherein said compound contains said components in quantity ranges, indicated in wt %, based on the entire compound, of:
a) epoxy prepolymer: 10 to 65%,
b) heat-activatable hardener for the prepolymer: 1 to 10%,
c) blowing agent: 0.5 to 10%,
d) thermoplastic non-reactive polyurethane: 1 to 50%,
e) block copolymer: 0 to 50,
f) rubber particles: 0 to 40%,
g) inorganic particles that comprise an envelope made of organic polymers: 0 to 40%,
h) fillers: 0 to 50%.

14. The thermally expandable and hardenable compound according to claim 13 wherein said compound contains said components in quantity ranges, indicated in wt % based on the entire compound, of:
a) epoxy prepolymer: 20 to 60%,
b) heat-activatable hardener for the prepolymer: 2 to 8%,
c) blowing agent: 1 to 5%,
d) thermoplastic non-reactive polyurethane: 5 to 35%,
e) block copolymer: 5 to 30%,
f) rubber particles: at least 5 and at most 25%,
g) inorganic particles that comprise an envelope made of organic polymers: at least 5 and at most 25%,
h) fillers: at least 5 and at most 30%.

15. An extruded or injection-molded shaped element made up of a thermally expandable and hardenable compound according to claim 1.
